(19) United States
(12) Patent Application Publication
(10) Pub. No.: US 2025/0199822 A1
(43) Pub. Date: Jun. 19, 2025

(54) ASSET LOADING ACCURACY THROUGH AUTOMATIC CORRECTION OF ASSET FILE PATHS

(71) Applicant: Tencent Technology (Shenzhen) Company Limited, Shenzhen (CN)

(72) Inventor: Zhidong Wang, Shenzhen (CN)

(21) Appl. No.: 19/056,275

(22) Filed: Feb. 18, 2025

Related U.S. Application Data
(63) Continuation of application No. PCT/CN2024/071133, filed on Jan. 8, 2024.

(30) Foreign Application Priority Data
Mar. 6, 2023 (CN) 202310242411.0

(51) Int. Cl. G06F 9/445; G06F 9/38

(52) U.S. Cl. CPC G06F 9/44521; G06F 9/3871

(57) ABSTRACT

Aspects described herein provide for an asset loading method in the field of data processing technologies. The method provides correcting asset paths based on an asset type and, as a result, improving asset loading accuracy and decreasing asset loading errors. Aspects described herein further provide for improvements to asynchronous and synchronous asset loading. Aspects described herein further provide for receiving a first asset loading request configured for asynchronous asset loading, obtaining an asset type of the first asset; correcting the asset path of the first asset based on the asset type of the first asset; and asynchronously loading the first asset based on a corrected asset path of the first asset.

### CROSS-REFERENCE TO RELATED APPLICATIONS

This application is a continuation application of PCT Application PCT/CN2024/071133, filed Jan. 8, 2024, which claims priority to Chinese Patent Application No. 202310242411.0, filed on Mar. 6, 2023, each entitled “IMPROVING ASSET LOADING ACCURACY THROUGH AUTOMATIC CORRECTION OF ASSET FILE PATHS”, and each which is incorporated herein by reference in its entirety.

### FIELD

Aspects described herein relate to the field of data processing technologies, and in particular, to an asset loading method.

### BACKGROUND

Asset loading is usually involved during running of a game engine-based virtual scene application.

When the game engine-based virtual scene application runs, an asset is asynchronously loaded in an asynchronous loading process, the asynchronously loaded asset is buffered in an internal memory of a computer device. When an asset is synchronously loaded in a synchronous loading process, the internal memory is queried for the buffered asset. During asynchronous loading, after an asset loading request is received, a corresponding asset may be loaded by using an asset path indicated by the asset loading request.

However, if the path indicated by the asset loading request is incorrect, an asset loading error may occur, and consequently, accuracy of asset loading is affected.

### SUMMARY

Aspects of this application provide an asset loading method and apparatus, a device, and a storage medium, to improve accuracy of asset loading. The technical solutions are as follows.

According to aspects described herein, an asset loading method is provided, performed by a computer device, the method including:
receiving a first asset loading request, the first asset loading request being configured for requesting to asynchronously load a first asset, and the first asset loading request indicating an asset path of the first asset;
obtaining an asset type of the first asset;
correcting the asset path of the first asset based on the asset type of the first asset in response to the asset type of the first asset not matching a format of the asset path of the first asset; and
asynchronously loading the first asset based on a corrected asset path of the first asset.

According to another aspect described herein, an asset loading apparatus is provided, including:
a first request receiving module, configured to receive a first asset loading request, the first asset loading request being configured for requesting to asynchronously load a first asset, and the first asset loading request including an asset path of the first asset;
an asset type obtaining module, configured to obtain an asset type of the first asset;
a path correction module, configured to correct the asset path of the first asset based on the asset type of the first asset in response to the asset type of the first asset not matching a format of the asset path of the first asset; and
a loading module, configured to asynchronously load the first asset based on a corrected asset path of the first asset.

According to a further aspect described herein, the path correction module is configured to:
obtain a suffix of the asset path of the first asset; and
correct the asset path of the first asset based on the asset type of the first asset in response to the asset type of the first asset not matching the suffix of the asset path of the first asset.

According to another aspect, the path correction module is configured to add a specified suffix to the asset path of the first asset in response to the asset type of the first asset being a blueprint type, and the suffix of the asset path of the first asset being not the specified suffix, to obtain the corrected asset path of the first asset.

According to another aspect, the path correction module is configured to remove a specified suffix of the asset path of the first asset in response to the asset type of the first asset being a non-blueprint type, and the suffix of the asset path of the first asset being the specified suffix, to obtain the corrected asset path of the first asset.

According to another aspect, the asset type obtaining module is configured to determine an asset type corresponding to an application programming interface (API) that receives the first asset loading request as the asset type of the first asset.

According to another aspect, the first asset loading request indicates asset paths of N assets, the N assets including the first asset, and N being an integer greater than or equal to 2;
the apparatus further includes:
an asset division module, configured to divide the asset paths of the N assets into at least two asset path sets in response to N being greater than a first threshold, a quantity of asset paths included in each of the asset path sets being not greater than the first threshold, and the N assets being loaded in batches by using the asset path set as a unit; and
the path correction module is configured to correct the asset path of the first asset based on the asset type of the first asset in response to an asset path set corresponding to a current processing batch including the first asset, and the asset type of the first asset not matching the format of the asset path of the first asset.

According to other aspects described herein, a computing device, comprising one or more processors and memory storing instructions that, when executed by the one or more processors, cause the computing device to:
an addition module, configured to add the first asset loading request to a waiting queue in response to a quantity of asynchronous asset loading request being processed reaching a second threshold; and
the path correction module is configured to: in response to the quantity of asynchronous asset loading requests being processed being less than the second threshold, and the first asset loading request being located first in the waiting queue, remove the first asset loading request from the waiting queue, and perform the operation of correcting the asset path of the first asset based on the asset type of the first asset in response to the asset type of the first asset not matching a format of the asset path of the first asset.

According to another aspect, the addition module is configured to insert the first asset loading request into the waiting queue based on a priority of the first asset loading request and a priority of an existing asynchronous asset loading request in the waiting queue.

According to another aspect, the computing device further includes:
a sorting module, configured to sort, in response to the waiting queue including at least two asynchronous asset loading requests, and the waiting queue meeting a sorting condition, the asynchronous asset loading requests in the waiting queue based on respective priorities of the at least two asynchronous asset loading requests.

According to another aspect, the sorting condition includes at least one of the following conditions:
the quantity of asynchronous asset loading requests being processed is less than the second threshold;
a time interval between a current moment and a first moment reaches a duration threshold, the first moment being a previous moment at which the asynchronous asset loading requests in the waiting queue are sorted; and
after the first moment, a quantity of asynchronous asset loading requests newly added to the waiting queue is not less than a third threshold.

According to another aspect, the computing device further includes:
a second request receiving module, configured to receive a second asset loading request, the second asset loading request being configured for requesting to asynchronously load a second asset;
a query module, configured to query an internal memory for the second asset, the internal memory storing an asset that is loaded by using an asynchronous asset loading request; and
a loading stop module, configured to stop, in response to the second asset being not found in the internal memory, a procedure of loading the second asset.

According to another aspect, a computer device is provided. The computer device includes a processor and a memory, the memory storing at least one computer program, the at least one computer program being loaded and executed by the processor to implement the asset loading method.

According to another aspect, a computer-readable storage medium is provided. The computer-readable storage medium stores at least one computer program, the computer program being loaded and executed by a processor to implement the asset loading method.

According to another aspect, a computer program product is provided. The computer program product includes a computer program, the computer program being stored in a computer-readable storage medium. A processor of a computer device reads the computer program from the computer-readable storage medium, and executes the computer program, to enable the computer device to perform the asset loading method provided in the various optional implementations.

The technical solutions provided in the embodiments of this application may have the following beneficial effects:

Aspects described herein may detect incorrect an incorrect asset path during asynchronous loading and correct the asset path based on an asset type. Aspects may further provide for improving asset loading accuracy by reducing synchronous asset loading errors, based on correcting asset paths during asynchronous loading.

### BRIEF DESCRIPTION OF THE DRAWINGS

FIG. 1 is a schematic diagram of an implementation environment according to an illustrative aspect of this application;

FIG. 2 is a flowchart of an asset loading method according to an aspect of this application;

FIG. 3 is a schematic diagram of configuring an asset through an asset configuration tool in a pipelined manner;

FIG. 4 is a framework diagram of implementation of asset loading in this application;

FIG. 5 is a flowchart of an asset loading method according to an aspect of this application;

FIG. 6 is a flowchart of an asset loading method according to an aspect of this application;

FIG. 7 is a flowchart of an asset loading method according to an aspect of this application;

FIG. 8 is a flowchart of an asset loading method according to an aspect of this application;

FIG. 9 is a flowchart of an asset loading method according to an aspect of this application;

FIG. 10 is a schematic diagram of read speeds of various levels of storage modules in a computer system;

FIG. 11 is a flowchart of synchronous asset loading in this application;

FIG. 12 is a flowchart of asynchronous asset loading in this application;

FIG. 13 is a flowchart of asynchronous waiting queue processing in this application;

FIG. 14 is a flowchart of asset path processing in batches in this application;

FIG. 15 is a block diagram of an asset loading apparatus according to an aspect of this application; and

FIG. 16 is a structural block diagram of a computer device according to an aspect of this application.

### DETAILED DESCRIPTION

To make objectives, technical solutions, and advantages of this application clearer, the following further describes implementations of this application in detail with reference to the accompanying drawings.

### (1) Asset Loading

During use of an asset, an application first needs to read the asset from an asset file (which may be stored in a hard disk or at a network location), and then store the asset into internal memory. The process of reading the asset from the asset file and storing the asset file into the internal memory is referred to as asset loading.

### (2) Preloading

Preloading is an optimization technology of running of an application and can significantly improve a key performance indicator. In a manner of loading an asset in advance, an asset that may be subsequently used by the application is loaded to an internal memory in advance, to improve asset loading efficiency during use of the asset by the application.

### (3) Asynchronous Loading

A process of starting other one or more processes other than a main process of an application to perform asset loading is referred to as asynchronous asset loading. Execution of the main process of the application is not affected by the asynchronous loading process.

### (4) Synchronous Loading

A process of performing asset loading by using a main process of an application is referred to as synchronous asset loading. During synchronous loading, the main process of the application needs to wait for completion of synchronous loading to perform a subsequent operation.

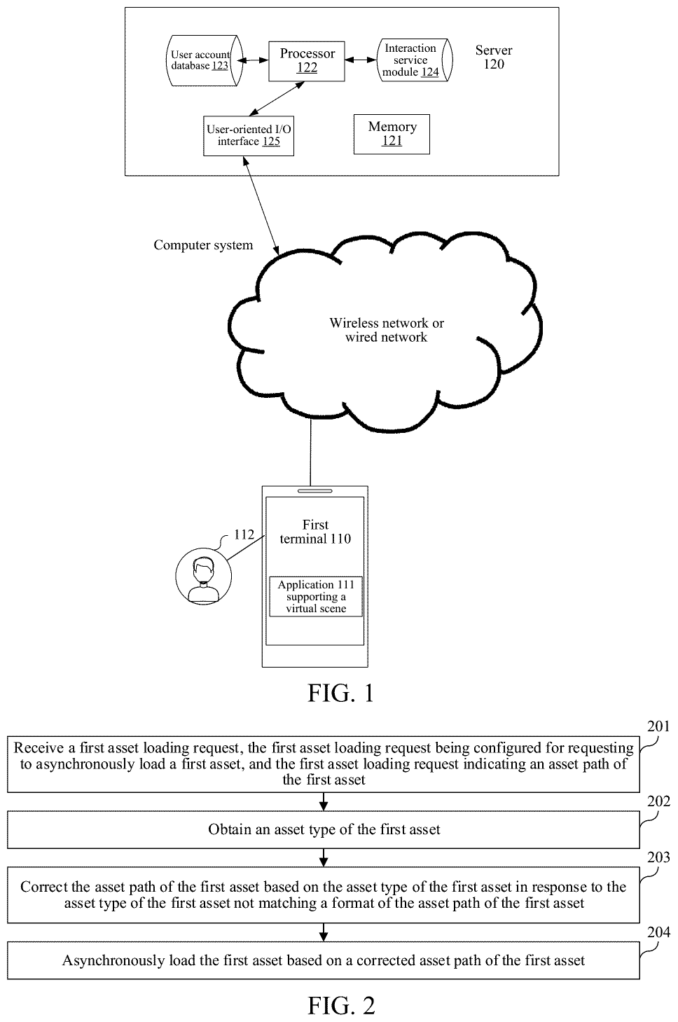

FIG. 1 is a schematic diagram of an implementation environment according to an aspect of this application. The implementation environment may include a first terminal 110 and a server 120.

An application 111 is installed and run on the first terminal 110. The application 111 may be an application developed based on a game engine. When the first terminal runs the application 111, a user interface of the application 111 is displayed on a screen of the first terminal 110. Application 111 may be a game, such as, but not limited to: a role playing game (RPG), a multiplayer online battle arena (MOBA) game, an escape shooting game, a simulation game (SLG), and/or others. The first terminal 110 is a terminal used by a first user 112. The first user 112 uses the first terminal 110 to control a virtual object A in a virtual scene to perform activities, and the virtual object A may be referred to as a main control virtual object of the first user 112. For example, the virtual object A is a first virtual person such as a simulated person or a cartoon person.

FIG. 1 shows only one terminal. However, a plurality of other terminals may access the server 120 in different aspects. In an aspect, one or more terminals are terminals corresponding to a developer. A developing and editing platform for the application supporting a virtual scene may be installed on the terminal. The developer may edit and update the application on the terminal and transmit an updated application installation package to the server 120 by using a wired or wireless network. The first terminal 110 may download the application installation package from the server 120 to update the application.

The first terminal 110 and one or more terminals are connected to the server 120 through a wireless network or a wired network.

The server 120 comprises at least one of the following: a server, a server cluster comprising a plurality of servers, a cloud computing platform, and/or a virtualization center. The server 120 is configured to provide a backend service for an application supporting a virtual scene. In an aspect, the server 120 is responsible for primary computing work, and the terminal is responsible for secondary computing work; or the server 120 is responsible for secondary computing work, and the terminal is responsible for primary computing work; or the server 120 and the terminal perform collaborative computing by using a distributed computing architecture between each other.

In a schematic example, the server 120 comprises a memory 121, a processor 122, a user account database 123, an interaction service module 124, and a user-oriented input/output (I/O) interface 125. The processor 122 may be configured to load instructions stored in the server 120, and process data in the user account database 123 and the interaction service module 124. The user account database 123 may be configured to store data of user accounts used by the first terminal 110 and the one or more other terminals, for example, avatars of the user accounts, nicknames of the user accounts, battle effectiveness indexes of the user accounts, and service zones of the user accounts. The interaction service module 124 is configured to provide a virtual scene for a user to interact with a virtual object of another user, for example, social interaction or battle. The user-oriented I/O interface 125 is configured to establish communication with the first terminal 110 via a wireless network or a wired network for data exchange.

In the related art, in an application that needs to perform asset loading, an asset path in an asset loading request needs to be manually configured by a developer. When there is a large quantity of assets in the application (for example, a game application may comprise an extremely large number assets), a format error of a configured asset path may be common. For example, the format error of the asset path may be caused because the developer does not properly configure the asset path based on a format corresponding to an asset type, or an error occurs when the asset path is configured, causing the asset path to have an incorrect format based on the asset type

Aspects described herein may provide for automatically correcting an asset path during asset loading to reduce occurrences of asset loading errors caused by an incorrect asset path configuration.

FIG. 2 is a flowchart of an asset loading method according to an aspect of this application. For ease of description, aspects may be described within context of a computer device executing the described operations. The computer device may be the first terminal 110 or the server 120 shown in FIG. 1. The executing device is not limiting. The method may include the following operations:

Operation 201: Receive a first asset loading request, the first asset loading request being configured for requesting to asynchronously load a first asset, and the first asset loading request indicating an asset path of the first asset.

The first asset may be non-executable data required during running of an application. Additionally or alternatively, the first asset may be any non-executable data logically deployed by an application. For example, the first asset may be displayed as an error message in the application, or displayed as a part of a user interface. The asset may comprise data in one or more forms, such as: a character string, an image, and a persistent object, and/or other forms.

The asset may be stored in an asset file, and a developer of the application may modify an asset used by the application without compiling the entire application again.

A game engine-based application (such as a game) is used as an example. The asset may comprise a virtual object (Actor), a blueprint, a mapping, a map, a video, audio, a particle, a material, a grid, and the like.

The game engine may be configured for program development in a plurality of fields such as a game development field, a virtual reality (VR) field, and/or a three-dimensional map field. The game engine comprises, but is not limited to, a three-dimensional game engine, a two-dimensional game engine, and/or the like. A type of the game engine is not limiting . . .

In a possible implementation, the first asset loading request may comprise the asset path of the first asset.

Alternatively, the first asset loading request may indirectly indicate the asset path of the first asset. For example, the first asset loading request may carry asset path indication information, and the computer device queries, based on the asset path indication information, for a prestored asset path corresponding to the asset path indication information.

The asset path may comprise storage locations of a corresponding asset at various levels. For example, the asset path may be a character string indicating storage locations and file names of a corresponding asset at various levels.

For example, an asset path “D:/xxGame/Actor/ziyuan.ziyuan1” indicates that the corresponding asset is an asset with a package name of “ziyuan1” in an asset file with a name of “ziyuan1” in a folder “Actor” in a folder “xxGame” in a D disk.

The foregoing asset path is described by using “D:/xxGame/Actor/ziyuan1” as an example. For different applications, an asset path setting rule may be different. The asset path setting rule is not limiting.

Operation 202: Obtain an asset type of the first asset.

The asset type may be preset by a developer. For example, the asset type may be a blueprint type asset or a non-blueprint type asset. Alternatively, the asset type may be further classified. For example, the non-blueprint type asset may be further classified as a particle type asset, a texture type asset, a material type asset, and the like.

Operation 203: Correcting the asset path of the first asset based on the asset type of the first asset in response to the asset type of the first asset not matching a format of the asset path of the first asset.

In this aspect of this application, when developing the application, the developer may set the format of the asset path based on a preset relationship between the format of the asset path and the asset type. In other words, different asset types may correspond to asset paths in different formats. After receiving an asynchronous asset loading request, based on detecting that a format of the requested asset path does not match the asset type, the computer device may correct, based on a format corresponding to the asset type of the asset, the format of the asset path indicated by the request. For example, when detecting that the format of the requested asset path does not match the asset type, the computer device may modify the format of the asset path indicated by the request to the format corresponding to the asset type of the asset.

Operation 204: Asynchronously load the first asset based on the corrected asset path of the first asset.

In this aspect, after correcting the asset path of the first asset, the computer device may perform asynchronous asset loading based on the corrected asset path of the first asset. For example, the computer device may read the corresponding first asset from a magnetic disk of the computer device, based on the corrected asset path of the first asset, and buffer the first asset in an internal memory.

In addition, if the asset type of the first asset matches the format of the asset path of the first asset, the computer device may load the first asset based on the asset path of the first asset in an asynchronous loading manner.

These illustrative aspects may be performed by an asset loading subsystem in the application.

In another aspect, assets in the application may be preconfigured, based on asset types, through offline pipeline collection.

For example, during an offline asset configuration stage of application development, application code may be parsed through an asset configuration tool in a pipelined manner, and the assets in the application may be gradually configured.

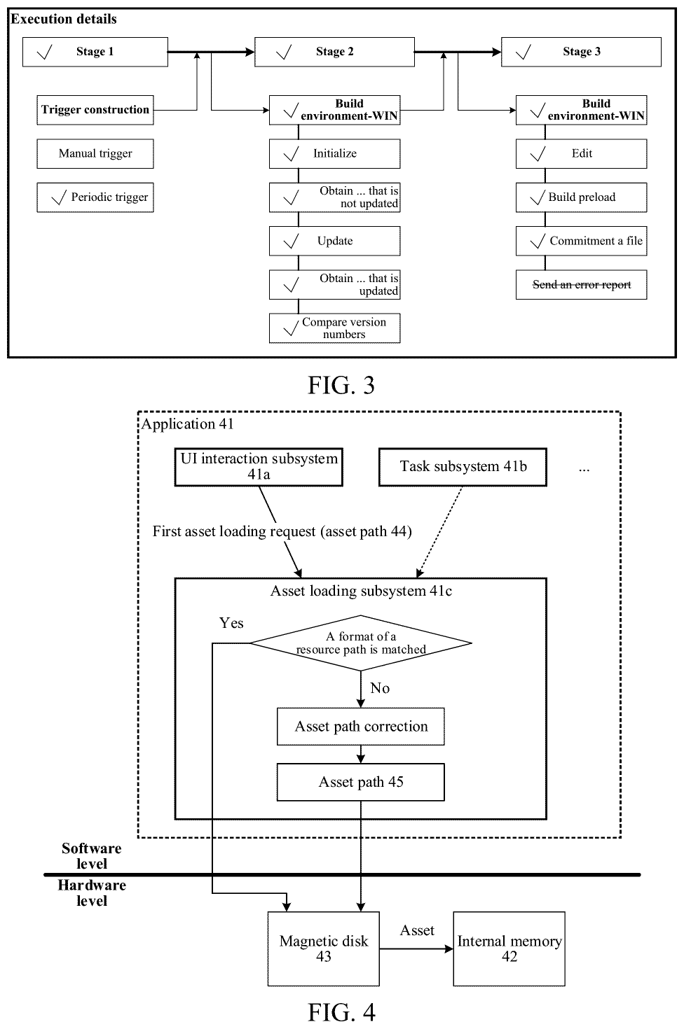

FIG. 3 is a schematic diagram of configuring an asset through an asset configuration tool in a pipelined manner.

For example, an asset corresponding to a skill of a game character in a game application may be configured through asset configuration. A skill used by the game character is first parsed through the asset configuration tool. For each skill, an asset of a corresponding skill may be parsed. Assets corresponding to a skill may comprise: a special effect, an animation, and/or other illustrative aspects of the corresponding skill.

In an aspect,, when an asynchronous asset loading request is received, an asset path indicated by the request may be matched with an asset type. If the asset path indicated by the request does not match the asset type, the asset path may be indicated by the request as incorrect. In this case, the asset path is corrected automatically based on the asset type, and then asset loading is performed based on a corrected asset path. According to this aspect, an asset path that may have an error may be corrected automatically based on the asset type to ensure accuracy of asset loading performed using the asset path and reduce asset loading errors can be reduced.

Aspects described above may be applied to any application performing asynchronous asset loading. For example, FIG. 4 is a framework diagram of implementation of asset loading in this application.

As shown in FIG. 4, at a software level, a software application such as a game engine-based application 41 runs on an operating system of a computer device. The application 41 comprises a plurality of subsystems that need to use an asset, for example, a UI interaction subsystem 41a and a task subsystem 41b, and an asset loading subsystem 41c for asset loading. Some functional interfaces in a game engine are encapsulated in each subsystem in the application 41.

At a hardware level, the computer device comprises an internal memory 42 and a magnetic disk 43. The magnetic disk 43 stores asset files of the application 41. In addition, the computer device further comprises necessary computer hardware such as a processor, a bus, and a power supply. Details are not described herein again.

During running of the application 41, when the subsystems such as the UI interaction subsystem 41a and the task subsystem 41b need to asynchronously load one or more assets, a first asset loading request may be sent to the asset loading subsystem 41c, where the first asset loading request comprises an asset path 44 of a first asset, to request to asynchronously load the first asset. After receiving the first asset loading request, the asset loading subsystem 41c first determines whether an asset type of the first asset matches a format of the asset path 44.

If the asset type of the first asset matches the format of the asset path 44, the asset loading subsystem 41c directly loads the first asset from the magnetic disk 43 to the internal memory 42 based on the asset path 44, and then returns the loaded first asset to the subsystem sending the first asset loading request 44.

If the asset type of the first asset does not match the format of the asset path 44, the asset loading subsystem 41c modifies the asset path 44 to a format matching the asset type of the first asset to obtain a corrected asset path 45. The asset loading subsystem 41c may then load the first asset from the magnetic disk 43 to the internal memory 42 based on the corrected asset path 45, and then returns the loaded first asset to the subsystem which sent the first asset loading request 44.

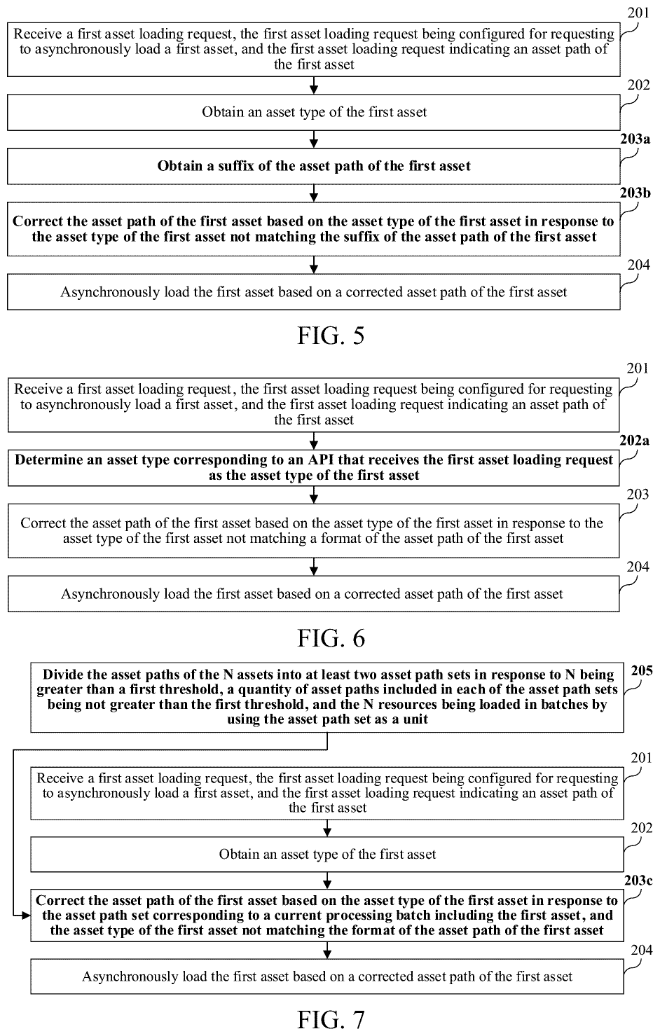

Based on the aspect in FIG. 2, refer to FIG. 5. FIG. 5 is a flowchart of an asset loading method according to an aspect of this application. Description of the aspect may be provided using a computer device as an execution body of operations. As shown in FIG. 5, operation 203 in the aspect in FIG. 2 may be implemented as operations 203a and 203b.

Operation 203a: Obtain a suffix of the asset path of the first asset.

In an aspect, different types of assets may be distinguished by using suffixes of the asset paths. After an asynchronous asset loading request is received, the suffix of the asset path of the first asset to be loaded may be first obtained. For example, a last specified symbol (for example, a symbol “.” or a symbol “_”) in the asset path of the first asset and a character after the last specified symbol are obtained as the suffix of the asset path of the first asset.

Operation 203b: Correct the asset path of the first asset based on the asset type of the first asset not matching the suffix of the asset path of the first asset.

After the suffix of the asset path of the first asset is obtained, whether the suffix of the asset path of the first asset meets a format of the suffix corresponding to the asset type of the first asset may be determined. If the suffix of the asset path of the first asset meets the format of the suffix corresponding to the asset type of the first asset, the suffix does not need to be corrected. Otherwise, if the suffix of the asset path of the first asset does not meet the format of the suffix corresponding to the asset type of the first asset, the suffix of the asset path of the first asset needs to be corrected based on the format of the suffix corresponding to the asset type of the first asset.

If the asset type of the first asset does not match the suffix of the asset path of the first asset, the computer device may modify the suffix of the asset path of the first asset to a suffix matching the asset type of the first asset.

Different suffixes may be pre-set for asset paths of different types of assets, and whether the asset paths are accurate may be determined by checking the suffixes. Logic of this process is simple, and configuration efficiency during development and processing efficiency during application can be ensured, so that development and execution efficiency of the application can be ensured.

In an aspect, correcting the asset path of the first asset based on the asset type of the first asset in response to the asset type of the first asset not matching the suffix of the asset path of the first asset may comprise:
adding a blueprint type suffix to the asset path of the first asset in response to the asset type of the first asset being a blueprint type and the suffix of the asset path of the first asset not being the blueprint type suffix, to obtain a corrected asset path of the first asset.

For example, an application based on an Unreal Engine 4™ (“UE 4”) engine (e.g., a game engine) is used as an example. In the UE 4 engine, a suffix of a blueprint type asset is preset as “_C”. When an asset type of the first asset is the blueprint type, if the suffix of the asset path of the first asset is not “_C”, it is determined that the asset path of the first asset needs to be corrected. In this case, the suffix “_C” may be added to the asset path of the first asset.

In another aspect, correcting the asset path of the first asset based on the asset type of the first asset in response to the asset type of the first asset not matching the suffix of the asset path of the first asset may comprise:
removing a specified suffix of the asset path of the first asset in response to the asset type of the first asset being a non-blueprint type and an asset path of a non-blueprint type not being the specified suffix, to obtain a corrected asset path of the first asset.

For example, in an application based on the UE 4 engine, a suffix “_C” is not set for a non-blueprint type asset. When an asset type of the first asset is the non-blueprint type, if the suffix of the asset path of the first asset is “_C”, it is determined that the asset path of the first asset needs to be corrected. In this case, the suffix “_C” may be directly removed from the asset path of the first asset.

In the foregoing aspects, assets are classified into two types of assets, namely, the blueprint type and the non-blueprint type, and an asset path may be corrected by adding or deleting a suffix. These aspects may provide for improving accuracy of asset loading while avoiding use of excessive processing capabilities and processing time of the computer device through process of checking and correcting the asset path, further ensuring execution efficiency of the asset loading.

In another aspect, descriptions are provided by using an illustrative suffix setting manner of the blueprint and non-blueprint type assets in the UE 4 engine. The suffix setting manner of the asset type is not limiting.

In another aspect, assets used by the application may also be classified according to another rule. An asset classification manner is not limited in this application.

For example, assets may be classified into a blueprint type asset, a material type asset, a grid type asset, and/or the like, and respectively set different suffixes for different asset types.

In addition, in aspects of this application, asset paths are distinguished and checked by using suffixes. In another aspect, the computer device may also distinguish and check the asset paths in another manner, such as, but not limited to: setting different prefixes for different types of assets, setting different fixed position fields, and/or others. This is not limited in this aspect of this application.

Based on the methods described in FIG. 2 and/or FIG. 5, FIG. 6 is a flowchart of an asset loading method according to an aspect of this application. For ease of description, descriptions are provided by merely using a computer device as an execution body of operations. As shown in FIG. 6, operation 202 in the aspect in FIG. 2 may be implemented as operation 202a.

Operation 202a: Determine an asset type corresponding to an API that receives the first asset loading request as the asset type of the first asset.

According to an aspect, different application programming interfaces (APIs) may be set for asset loading requests corresponding to different asset types, and when the first asset loading request is received, the asset type of the first asset requested to be loaded may be determined through the API corresponding to the first asset loading request.

When developing the application, for asynchronous asset loading logic, the developer may configure different APIs for different types of assets in an asset loading subsystem. When requesting to load an asset, a subsystem using an asset in the application may invoke an API corresponding to a type of the asset to be loaded to send the first asset loading request to the asset loading subsystem. Correspondingly, the asset loading subsystem determines a corresponding asset type based on the API that receives the first asset loading request.

According to this aspect, the computer device may determine the asset type of the corresponding asset path based on the API receiving the request, and does not need to configure another message or field to indicate the asset type corresponding to the first asset loading request, which may improve efficiency of obtaining the asset type while the application is running.

According to this aspect, a manner in which the computer device obtains the asset type is described merely by using an example in which the asset type is determined based on the API. In another aspect, the computer device may also determine the asset type in another manner.

For example, in another aspect, the first asset loading request may comprise an asset type indication field. The asset type indication field may indicate an asset type corresponding to an asset path indicated by the first asset loading request. When the computer device runs the application, after receiving the first asset loading request, the asset loading subsystem parses the asset type indication field in the first asset loading request, and determines the asset type of the first asset.

In this aspect, the developer does not need to develop different APIs for the asset loading subsystem, which may improve application development efficiency.

Based on the aspect(s) in one or more of FIG. 2, FIG. 5, and FIG. 6, refer to FIG. 7. FIG. 7 is a flowchart of an asset loading method according to an aspect of this application. Descriptions are provided using a computer device as an illustrative execution body of operations. As shown in FIG. 7, the first asset loading request indicates asset paths of N assets, the N assets including the first asset, and N being an integer greater than or equal to 2. Before operation 203, operation 205 may be further included. Operation 203 in the aspect in FIG. 2 may alternatively be implemented as operation 203c.

Operation 205: Divide the asset paths of the N assets into at least two asset path sets in response to N being greater than a first threshold, a quantity of asset paths included in each of the asset path sets being not greater than the first threshold, and the N assets being loaded in batches by using the asset path set as a unit.

According to an aspect, when the computer device processes the first asset loading request, if the first asset loading request indicates a quantity of asset paths greater than a first threshold, the computer device may divide all the asset paths indicated by the first asset loading request into at least two batches for loading, so that a quantity of assets loaded in each batch is less than the first threshold.

For example, when processing the first asset loading request, if the quantity of asset paths of the N assets indicated by the first asset loading request is greater than the first threshold, M asset paths are extracted from the asset paths of the N assets in an order from first to last, where a value of M is a positive integer, and the value of M is equal to the first threshold, and the extracted M asset paths are divided into a first asset path set. Then, if a quantity of remaining asset paths is greater than M, M asset paths are extracted from the remaining asset paths in an order from first to last, and the extracted M asset paths are divided into a second asset path set. If a quantity of remaining asset paths is not greater than M, all the remaining asset paths are added to the second asset path set. Otherwise, the foregoing operations are repeated until all the N asset paths are divided.

Loading in batches means sequential loading of a plurality of batches of assets. After loading of one batch of assets is completed, an asset loading process of a next batch is processed.

Operation 203c: Correct the asset path of the first asset based on the asset type of the first asset, wherein an asset path set corresponding to a current processing batch comprises the first asset, and the asset type of the first asset not matching the format of the asset path of the first asset.

In a processing batch comprising the first asset, the computer device may perform a process of checking and correcting the asset path of the first asset. This may avoid affecting execution of another process because when a quantity of asset paths requested to be loaded is excessively large, excessive processes in the processing batch may be occupied by checking and correcting the asset paths.

For a process of checking and correcting the asset path in operation 203c, refer to operation 230a and operation 203b in the aspect in FIG. 3.

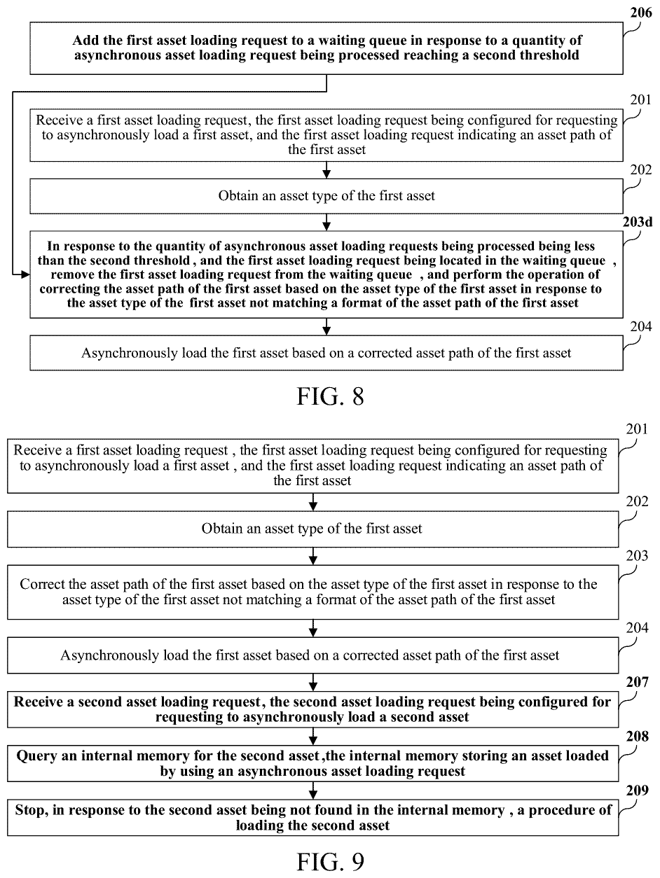

Based on the aspect(s) in one or more of FIG. 2, FIG. 5, FIG. 6, and FIG. 7, refer to FIG. 8. FIG. 8 is a flowchart of an asset loading method according to an aspect of this application. For ease of description, descriptions are provided by merely using a computer device as an execution body of operations. As shown in FIG. 8, before operation 203, operation 206 may be further included. Operation 203 in the aspect in FIG. 2 may alternatively be implemented as operation 203d.

Operation 206: Add the first asset loading request to a waiting queue in response to a quantity of asynchronous asset loading request being processed reaching a second threshold.

In an aspect of this application, when there are excessive asynchronous asset loading requests to be processed, to avoid occupation of excessive processing capabilities caused by simultaneous processing of the excessive asynchronous asset loading requests, when receiving the first asset loading request, the computer device may first check a quantity of asynchronous asset loading requests currently being processed, and temporarily skip processing the first asset loading request if the quantity of asynchronous asset loading requests currently being processed reaches the second threshold, but add the first asset loading request to the waiting queue.

Operation 203d: In response to the quantity of asynchronous asset loading requests being processed being less than the second threshold, and the first asset loading request being located first in the waiting queue, remove the first asset loading request from the waiting queue, and perform the operation of correcting the asset path of the first asset based on the asset type of the first asset in response to the asset type of the first asset not matching a format of the asset path of the first asset.

Subsequently, when the quantity of asynchronous asset loading requests being processed is less than the second threshold, the computer device may extract a new asset loading request from the head of the waiting queue for asset loading.

According to an aspect, the computer device may control a quantity of asynchronous asset loading requests simultaneously being processed, to avoid occupation of excessive processing capabilities caused by excessive asynchronous asset loading requests simultaneously being processed, and ensure a processing capability of another process other than asset loading in the application, so as to ensure a running effect of the application, for example, a frame freezing situation during running of the application.

For a process of checking and correcting the asset path in operation 203d, refer to operation 230a and operation 203b in the aspect in FIG. 3.

According to another aspect, adding the first asset loading request to a waiting queue comprises:
inserting the first asset loading request into the waiting queue based on a priority of the first asset loading request and a priority of an existing asynchronous asset loading request in the waiting queue.

In this aspect, when the first asset loading request is added to the waiting queue, the first asset loading request may be inserted into the waiting queue based on the priority of the first asset loading request. The priority of the first asset loading request may be determined based on factors such as a type of an asset requested by the first asset loading request, asset importance, and request time.

Inserting the first asset loading request into the waiting queue based on a priority of the first asset loading request and a priority of an existing asynchronous asset loading request in the waiting queue may mean that, when the priority of the existing asynchronous asset loading request in the waiting queue is lower than the priority of the first asset loading request, the first asset is inserted into the waiting queue before the existing asynchronous asset.

According to this aspect, when the first asset loading request is added to the waiting queue, an arrangement sequence of requests in the waiting queue may be obtained, so that accuracy of the arrangement sequence of the requests in the waiting queue can be ensured at any time.

Additionally or alternatively, in response to the waiting queue comprising at least two asynchronous asset loading requests, and the waiting queue meeting a sorting condition, the asynchronous asset loading requests in the waiting queue are sorted based on respective priorities of the at least two asynchronous asset loading requests.

After the first asset loading request is added to the waiting queue, when the sorting condition is met, the at least two asynchronous asset loading requests included in the waiting queue may be sorted based on the priorities. In this aspect, sorting does not need to be performed each time a request is added. This reduces complexity of a processing process.

Asynchronous asset loading requests in the waiting queue may be sorted based on respective priorities of the at least two asynchronous asset loading requests, in descending order of the priorities.

According to an aspect, the sorting condition comprises at least one of the following conditions:
the quantity of asynchronous asset loading requests being processed is less than the second threshold;
a time interval between a current moment and a first moment reaches a duration threshold, the first moment being a previous moment at which the asynchronous asset loading requests in the waiting queue are sorted; and
after the first moment, a quantity of asynchronous asset loading requests newly added to the waiting queue is not less than a third threshold.

According to this aspect, the computer device may trigger, based on an interval of duration, and/or based on an interval of a quantity of newly added asynchronous asset loading requests, and/or when a new asynchronous asset loading request needs to be initiated, to sort, based on the priorities, the at least two asynchronous asset loading requests included in the waiting queue. The computer device does not need to sort the at least two asynchronous asset loading requests each time a request is added. This reduces processing complexity.

Based on the aspect(s) in one or more of FIG. 2, FIG. 5, and FIG. 8, refer to FIG. 9. FIG. 9 is a flowchart of an asset loading method according to an aspect of this application. For ease of description, descriptions are provided by merely using a computer device as an execution body of operations. As shown in FIG. 9, after operation 204, the method may further comprise operation 207 to operation 209:

Operation 207: Receive a second asset loading request, the second asset loading request being configured for requesting to asynchronously load a second asset.

In addition to supporting asynchronous asset loading, a further aspect supports synchronous asset loading. Specifically, for example, a subsystem using an asset in the application may send, to the asset loading subsystem, the second asset loading request for synchronously loading the second asset, to obtain a needed asset from the asset loading subsystem.

Operation 208: Query an internal memory for the second asset, the internal memory storing an asset that is loaded by using an asynchronous asset loading request; and

In this aspect, during synchronous asset loading, after receiving the second asset loading request, the asset loading subsystem may directly query the internal memory for the second asset.

Operation 209: Stop, in response to the second asset being not found in the internal memory, a procedure of loading the second asset.

In this aspect, during synchronous loading, after receiving a synchronous loading request, the computer device may directly query the internal memory for a corresponding asset, and if there is no corresponding asset in the internal memory, the loading process is no longer performed, to prevent a main process of the application from being blocked by the synchronous loading process.

The second asset is returned to a sender of the second asset request in response to the second asset being found in the internal memory.

According to this aspect, during synchronization asset loading, if the computer device does not find the second asset from the internal memory, the computer device may no longer perform a process of loading the second asset from a magnetic disk to the internal memory, to avoid a case in which the process blocks execution of the main process of the application, preventing a flush function from being triggered, and reducing frame freezing of the application.

A null value may be returned to the sender of the second asset request in response to the second asset being not found in the internal memory.

In another possible implementation, in response to the second asset being not found in the internal memory, a third asset that specifically has an asset subtype the same as that of the second asset may be returned to the sender of the second asset request, where the third asset is configured for indicating a load failure of the second asset. The asset subtype is most detailed classification of assets in the application. In other words, the third asset is used to replace the second asset, and a subsystem using the second asset may directly use the third asset to replace the second asset, to perform a subsequent processing operation.

For example, the third asset may be a visual asset (for example, a particle asset, a material asset, a picture asset, and/or an animation asset) or an audio asset. The visual asset or the audio asset may be directly used, based on use logic of the second asset, by a subsystem that is in the application and that sends the second asset loading request. That is, the second asset that originally needs to be used is replaced with the third asset of the same subtype. When the third asset is presented or played on an interface of the application, the third asset may be configured for prompting a user that the second asset is unsuccessfully loaded.

For example, when the second asset is a skill effect, if the second asset does not exist in the internal memory, the asset loading subsystem may return a skill effect asset that replaces the second asset, and an effect when the skill effect asset is displayed is prompting that an original skill effect is loaded incorrectly.

Aspects described above may be applied to a test stage of the application, such that when testing the application, a tester may quickly determine a problem or a vulnerability in the application by using an effect of an asset displayed or played on the interface, so that the tester can quickly locate code or an asset with a problem, thereby improving efficiency of testing the application.

For example, aspects described herein may be applied to a game application based on a UE 4 engine. In this solution, a manner of encapsulating and optimizing a native loading interface is used, to improve asset loading performance and an error-tolerant rate during use. Asset preloading is mainly performed in a manner of asset classification and offline asset acquisition. In this way, better game experience can be provided, frame freezing caused by an asset configuration error can be avoided, and development efficiency can be improved.

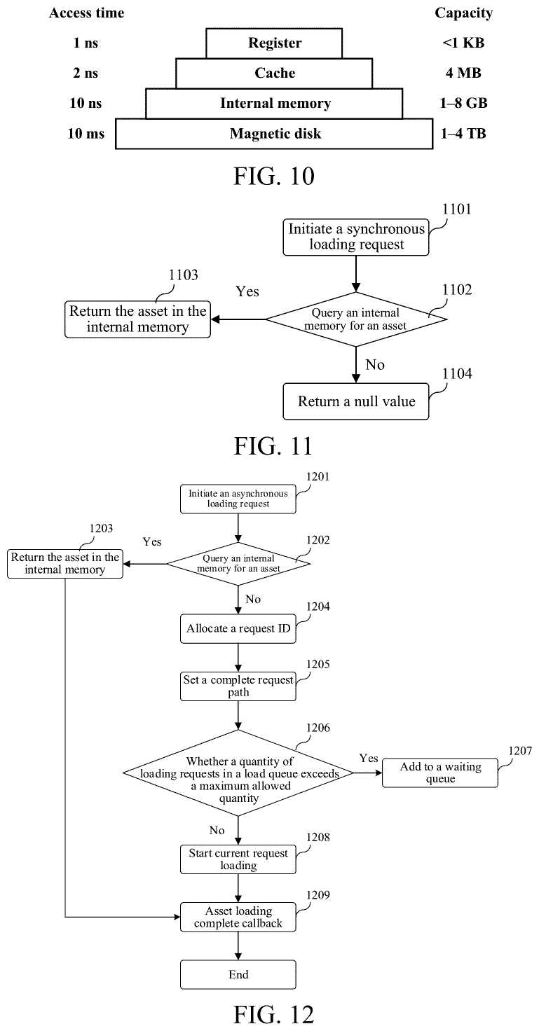

FIG. 10 is a schematic diagram of read speeds of various levels of storage modules in a computer system. As shown in FIG. 10, in the computer system, a speed at which an application reads data from an internal memory is much higher than a speed at which the application reads data from a magnetic disk. Therefore, during running of the application, an asset to be used needs to be first loaded from the magnetic disk to the internal memory in an asset loading manner, and then the asset is obtained from the internal memory for use, thereby improving asset use efficiency.

In this aspect, a default synchronization load interface is encapsulated, and the synchronization load interface performs only cache internal memory query and does not trigger synchronization load, to avoid a case in which frame freezing is caused by triggering a Flush function during synchronization loading and degrades game experience.

FIG. 11 is a flowchart of synchronous asset loading in this application. As shown in FIG. 11, synchronization asset loading comprises the following operations:
(1) Initiate a synchronous loading request to input an asset path that needs to be loaded (operation S1101).
(2) FindObject processing (internal memory query) is performed on a loading system to determine whether the asset is loaded in an internal memory (operation S1102), and if the internal memory query succeeds, an asset object is directly returned (operation S1103). If the query of the internal memory for FindObject fails, a null value is returned (operation S1104).

In this solution, an asynchronous asset load interface is encapsulated, an asset path is detected before asynchronous request, accuracy of an ordinary asset type and a blueprint asset path is ensured, and an asset path is automatically corrected based on a path error.

FIG. 12 is a flowchart of asynchronous asset loading in this application. As shown in FIG. 12, asynchronous asset loading comprises the following operations:
((1) Initiate an asynchronous asset loading request to input an asset path that needs to be loaded (operation S1201).
(2) FindObject processing (internal memory query) is performed on a loading system to determine whether the asset is loaded in an internal memory (operation S1202), and if the internal memory query succeeds, an asset object is directly returned (operation S1203). The internal memory query fails, a loading proxy object RequestData object is dynamically created, and a unique request Identity (ID) is allocated to the RequestData object (operation S1204), a complete request path is set (operation S1205), whether a quantity of loading requests in a current load queue exceeds a maximum allowed quantity is determined (operation S1206), and if the quantity exceeds a maximum loading request quantity, RequestData is added to a waiting queue (operation S1207), or if the quantity does not exceed a maximum loading request quantity, and current request loading is started (operation S1208).
(3) Asset loading complete callback RequestData:: Executed () notify an asset loading and binding function (operation S1209), and complete the asynchronous asset loading.

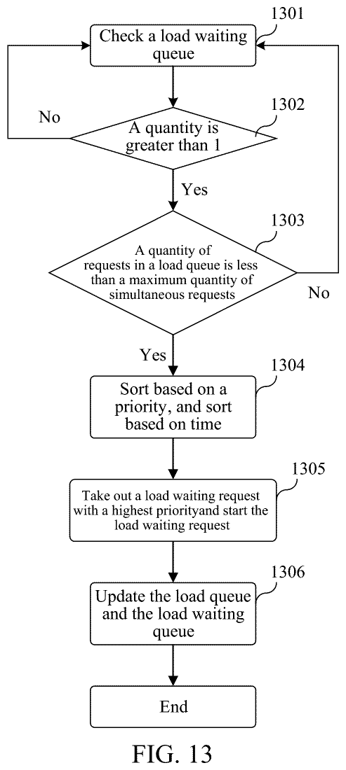

When there are excessive loading requests simultaneously, the loading requests are processed from the waiting queue based on priorities. FIG. 13 is a flowchart of asynchronous waiting queue processing in this application. As shown in FIG. 13, asynchronous waiting queue processing comprises the following operations:

Check a load waiting queue in real time (operation S1301), and determine whether a quantity of load waiting queues is greater than 1 (operation S1302). If the quantity is not greater than 1, perform operation S1301; or if the quantity is greater than 1, determine whether a quantity of requests in the current load queue is less than a maximum quantity of simultaneous requests (operation S1303). If the quantity is not less than the maximum quantity of simultaneous requests, perform S1301; or if the quantity is less than the maximum quantity of simultaneous requests, sort priorities of the waiting load queues and then perform sorting based on request time (operation S1304). Take out a load waiting request with a highest priority, and start the loading request (operation S1305); update the load waiting queue, remove the loading request that has been started, and complete the asynchronous waiting queue processing (operation S1306).

In this aspect, when requesting loading of a large quantity of asset paths, asset loading in batches is performed based on a maximum quantity of loading assets in a single batch, until loading of all assets is completed, and a loading completion notification is returned.

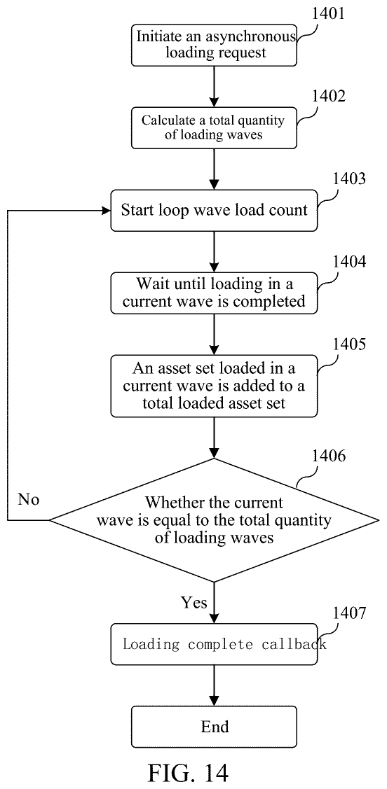

FIG. 14 is a flowchart of asset path processing in batches in this application. As shown in FIG. 14, asset path processing in batches comprises the following operations:
(1) Initiate an asynchronous asset loading request (operation S1401), and obtain RequestData request data. The RequestData data comprises a request ID (ReqID), a total data set of load paths (LoadedSoftPaths), a priority (where a default value of a loading priority is a low priority), a loading complete callback (CompletedDel), and FrameMaxLoadAssetPaths (where a default value of a maximum quantity of loading assets of a single wave is 100).
(2) Calculate a total quantity of loading waves that a current asynchronous loading request needs to process (operation S1402), where total quantity of loading waves (Total LoadCount)=total data set of load paths (LoadedSoftPaths)/maximum quantity of loading assets of a single wave (FrameMax LoadAssetPaths).
(3) If the total quantity of loading waves (Total LoadCount) is greater than 1, start loop wave load count (operation S1403), wait until loading in a current wave is completed (operation S1404), add an asset set loaded in the current wave to LoadedAssets, that is, a total loaded asset set (operation S1405), and increase a current wave count (CurrentLoadCount) by one.
(4) Determine whether CurrentLoadCount is equal to the total quantity of loading waves (operation S1406). If CurrentLoadCount is equal to the total quantity of loading waves, perform operation S1407; or if CurrentLoadCount is not equal to the total quantity of loading waves, perform operation S1403 until the current wave count (CurrentLoadCount) is equal to the total quantity of loading waves (Total LoadCount).

Once all loaded assets LoadedAssets (total loaded asset set) are integrated, issue the loading complete callback (CompletedDel), and complete the asset path processing in batches (operation S1407).

Aspects described herein may be applied to asset loading and preloading of an open large world based on a game engine such as a UE 4. In a large world type game, asset loading works at any time. As a system that works at high frequency, it is especially important to ensure time consumption of a single-frame processor and improve an error-tolerant rate during use. According to aspects described herein, another system in the game does not need to worry about high load caused by a large quantity of requests, and does not need to worry about a path check efficiency problem caused by loading of a large quantity of assets once. In addition, an encapsulated system does not invoke a LoadObject Flush central processing unit (CPU) to cause frame freezing, and synchronous loading is optimized in a form of cache query and preloading.

Specifically, the method provided in this application has the following effects:
(1) For the developer, an efficiency problem caused by a native interface may not be considered, and performance optimization is integrated in an encapsulated system by using a loading interface at any time.
(2) An offline classification asset collection policy is used, to store a path into an asset preload table by using an object ID as a key, and reference addition and duplication are performed based on the object ID during running, to load and clean cache.
(3) Asset classification is performed during asset collection, so that asset use situations of each module and each system can be more friendly counted, and preloading further ensures good and smooth game experience.

The following is an apparatus which can be configured for executing the method aspects described herein. For details not disclosed in with respect to the apparatus, refer to the method aspects described above.

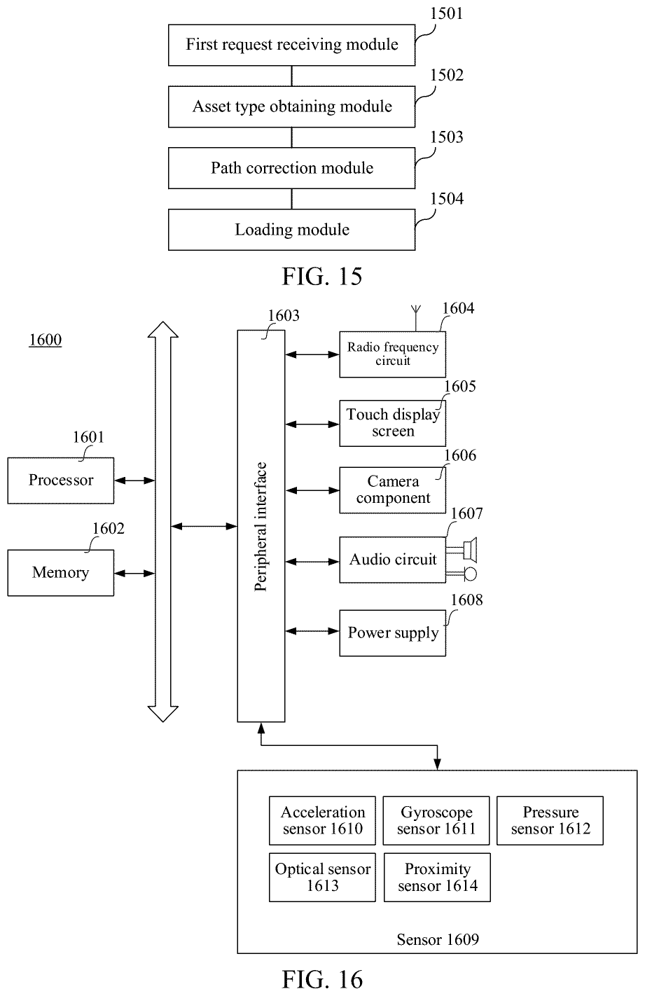

FIG. 15 is a block diagram of an asset loading apparatus according to an aspect described herein. The apparatus may include:
a first request receiving module 1501, configured to receive a first asset loading request, the first asset loading request being configured for requesting to asynchronously load a first asset, and the first asset loading request including an asset path of the first asset;
an asset type obtaining module 1502, configured to obtain an asset type of the first asset;
a path correction module 1503, configured to correct the asset path of the first asset based on the asset type of the first asset in response to the asset type of the first asset not matching a format of the asset path of the first asset; and
a loading module 1504, configured to asynchronously load the first asset based on a corrected asset path of the first asset.

In a possible implementation, the path correction module 1503 is configured to:
obtain a suffix of the asset path of the first asset; and
correct the asset path of the first asset based on the asset type of the first asset in response to the asset type of the first asset not matching the suffix of the asset path of the first asset.

According to an aspect, the path correction module 1503 is configured to add a specified suffix to the asset path of the first asset in response to the asset type of the first asset being a blueprint type, and the suffix of the asset path of the first asset being not the specified suffix, to obtain the corrected asset path of the first asset.

According to another aspect, the path correction module 1503 is configured to remove a specified suffix of the asset path of the first asset in response to the asset type of the first asset being a non-blueprint type, and the suffix of the asset path of the first asset being the specified suffix, to obtain the corrected asset path of the first asset.

According to another aspect, the asset type obtaining module 1502 is configured to determine an asset type corresponding to an application programming interface (API) that receives the first asset loading request as the asset type of the first asset.

According to another aspect, the first asset loading request indicates asset paths of N assets, the N assets including the first asset, and N being an integer greater than or equal to 2;
the apparatus further comprises:
an asset division module, configured to divide the asset paths of the N assets into at least two asset path sets in response to N being greater than a first threshold, a quantity of asset paths included in each of the asset path sets being not greater than the first threshold, and the N assets being loaded in batches by using the asset path set as a unit; and
the path correction module 1503 is configured to correct the asset path of the first asset based on the asset type of the first asset in response to an asset path set corresponding to a current processing batch including the first asset, and the asset type of the first asset not matching the format of the asset path of the first asset.

According to another aspect, the apparatus further comprises:
an addition module, configured to add the first asset loading request to a waiting queue in response to a quantity of asynchronous asset loading request being processed reaching a second threshold; and
the path correction module 1503 is configured to: in response to the quantity of asynchronous asset loading requests being processed being less than the second threshold, and the first asset loading request being located first in the waiting queue, remove the first asset loading request from the waiting queue, and perform the operation of correcting the asset path of the first asset based on the asset type of the first asset in response to the asset type of the first asset not matching a format of the asset path of the first asset.

According to another aspect, the addition module is configured to insert the first asset loading request into the waiting queue based on a priority of the first asset loading request and a priority of an existing asynchronous asset loading request in the waiting queue.

According to another aspect, the apparatus further comprises:
a sorting module, configured to sort, in response to the waiting queue including at least two asynchronous asset loading requests, and the waiting queue meeting a sorting condition, the asynchronous asset loading requests in the waiting queue based on respective priorities of the at least two asynchronous asset loading requests.

According to this aspect, the sorting condition further comprises at least one of the following conditions:
the quantity of asynchronous asset loading requests being processed is less than the second threshold;
a time interval between a current moment and a first moment reaches a duration threshold, the first moment being a previous moment at which the asynchronous asset loading requests in the waiting queue are sorted; and
after the first moment, a quantity of asynchronous asset loading requests newly added to the waiting queue is not less than a third threshold.

According to another aspect, the apparatus further comprises:
a second request receiving module, configured to receive a second asset loading request, the second asset loading request being configured for requesting to asynchronously load a second asset;
a query module, configured to query an internal memory for the second asset, the internal memory storing an asset that is loaded by using an asynchronous asset loading request; and
a loading stop module, configured to stop, in response to the second asset being not found in the internal memory, a procedure of loading the second asset.

In conclusion, aspects described herein provide that when an asynchronous asset loading request is received, an asset path indicated by the request is first matched with an asset type. If the asset path indicated by the request does not match the asset type, it indicates that the asset path indicated by the request is incorrect. In this case, the asset path is corrected automatically based on the asset type, and then asset loading is performed based on a corrected asset path, so that an asset loading error can be reduced, thereby improving accuracy of the asset loading.

FIG. 16 is a structural block diagram of a computer device 1600 according to an illustrative aspect of this application. The computer device 1600 may be a terminal device such as a VR device, an AR device, a smartphone, a tablet computer, a Moving Picture Experts Group Audio Layer III (MP3) player, or a Moving Picture Experts Group Audio Layer IV (MP4) player. The computer device 1600 may be further referred to as another name such as user equipment or a portable terminal.

Generally, the computer device 1600 comprises a processor 1601 and a memory 1602.

The memory 1602 may include one or more computer-readable storage media. The computer-readable storage medium may be tangible and non-transient. The memory 1602 may further include a high-speed random access memory (RAM), and a non-volatile memory such as one or more magnetic disk storage devices or flash storage devices. In some aspects, a non-transitory computer-readable storage medium in the memory 1602 is configured to store at least one instruction, the at least one instruction being configured to be executed by the processor 1601 to implement the method provided in the aspects of this application.

In some aspects, the computer device 1600 further comprises a peripheral device interface 1603 and at least one peripheral device. Specifically, the peripheral comprises: at least one of a radio frequency (RF) circuit 1604, a touch display screen 1605, a camera component 1606, an audio circuit 1607, and a power supply 1608.

In some aspects, the computer device 1600 may also include one or more sensors 1609. The one or more sensors 1609 include, but are not limited to, an acceleration sensor 1610, a gyroscope sensor 1611, a pressure sensor 1612, an optical sensor 1613, and a proximity sensor 1614.

A person skilled in the art may understand that the structure shown above does not constitute any limitation on the computer device 1600, and the computer device may include more components or fewer components than those shown in the figure, or some components may be combined, or a different component deployment may be used.

In an illustrative aspect, a computer-readable storage medium is further provided, storing at least one instruction, at least one program, a code set, or an instruction set, the at least one instruction, the at least one program, the code set, or the instruction set, when executed by a processor, implementing the foregoing asset loading method.

In another illustrative aspect, a computer program product or a computer program is provided. The computer program product or the computer program comprises computer instructions, and the computer instructions are stored in a computer-readable storage medium. A processor of a computer device reads the computer instructions from the computer-readable storage medium and executes the computer instructions, to enable the computer device to perform the foregoing asset loading method.

“Plurality of” mentioned in this specification means two or more. “And/or” describes an association relationship for describing associated objects and represents that three relationships may exist. For example, A and/or B may represent the following three cases: Only A exists, both A and B exist, and only B exists. The character “/” in this specification generally indicates an “or” relationship between the associated objects.

The foregoing descriptions are merely illustrative aspects of this application and do not limit this application. Any modification, equivalent replacement, or improvement made without departing from the spirit and principle of this application shall fall within the protection scope of this application.

What is claimed is:

1. A method comprising:
receiving a first asset loading request, the first asset loading request configured to asynchronously load a first asset, and the first asset loading request indicating a first asset path of the first asset;
obtaining a first asset type of the first asset;
determining whether the first asset path matches an asset path format of the first asset type;
based on determining that first asset path does not match an asset path format of the first asset type, correcting the first asset path; and
asynchronously loading the first asset based on the corrected first asset path.

2. The method according to claim 1, wherein determining whether the first asset path matches an asset path format of the first asset type further comprises:
obtaining a suffix of the first asset path;
comparing the suffix of the first asset path to a suffix corresponding to the first asset type.

3. The method according to claim 2, wherein correcting the first asset path further comprises:
adding a specified suffix to the first asset path, wherein the specified suffix corresponds to the asset path format of the first asset type.

4. The method according to claim 2, wherein correcting the first asset path further comprises:
removing a specified suffix from the first asset path, wherein the specified suffix does not correspond to the asset path format of the first asset type.

5. The method according to claim 1, wherein obtaining the first asset type comprises:
determining the first asset type based on an application programming interface (API), wherein the API receives the first asset loading request.

6. The method according to claim 1, wherein the first asset loading request indicates asset paths of a plurality of assets, and wherein receiving the first asset loading request further comprises:
based on a number of assets in the plurality of assets being greater than a first threshold, dividing the plurality of assets into a plurality of asset path sets, wherein each asset path set has a number of asset paths not greater than the first threshold,
loading, as a batch, a first asset path set from the plurality of asset path sets; and
selecting, from the first asset path set, the first asset path of the first asset.

7. The method according to claim 1, wherein receiving the first asset loading request further comprises:
based on a quantity of asynchronous asset loading requests being processed reaching a second threshold, adding the first asset loading request to a waiting queue; and
based on the quantity of asynchronous asset loading requests being processed being less than the second threshold and the first asset loading request being first in the waiting queue, removing the first asset loading request from the waiting queue.

8. The method according to claim 7, wherein adding the first asset loading request to a waiting queue comprises:
inserting the first asset loading request into the waiting queue based on a priority of the first asset loading request and a priority of one or more existing asynchronous asset loading requests in the waiting queue.

9. The method according to claim 7, further comprising:
sorting, based on the waiting queue comprising at least two asynchronous asset loading requests and on the waiting queue meeting a sorting condition, the asynchronous asset loading requests in the waiting queue, wherein the asynchronous asset loading requests are sorted based a respective priority of each asynchronous asset loading request.

10. The method according to claim 9, wherein the sorting condition comprises at least one of:
the quantity of asynchronous asset loading requests being processed is less than the second threshold;
a time interval between a current moment and a first moment reaches a duration threshold, the first moment being a previous moment when the asynchronous asset loading requests in the waiting queue were sorted; or
wherein the time interval between a current moment and after the first moment reaches the duration threshold and a quantity of asynchronous asset loading requests added to the waiting queue after the first moment is not less than a third threshold.

11. The method according to claim 1, further comprising:
receiving a second asset loading request, the second asset loading request configured to asynchronously load a second asset;
querying an internal memory for the second asset, wherein the internal memory stores assets previously loaded based on one or more asynchronous asset loading requests; and
based on the second asset not finding second asset in the internal memory, stopping a procedure to load the second asset.

12. A computing device, comprising:
one or more processors; and
memory storing instructions that, when executed by the one or more processors, cause the computing device to:
receiving a first asset loading request, the first asset loading request configured to asynchronously load a first asset, and the first asset loading request indicating a first asset path of the first asset;
obtaining a first asset type of the first asset;
determining whether the first asset path matches an asset path format of the first asset type;
based on determining that first asset path does not match an asset path format of the first asset type, correcting the first asset path; and
asynchronously loading the first asset based on the corrected first asset path.

13. The computing device of claim 12, wherein determining whether the first asset path matches an asset path format of the first asset type further comprises:
obtaining a suffix of the first asset path;
comparing the suffix of the first asset path to a suffix corresponding to the first asset type.

14. The computing device of claim 13, wherein correcting the first asset path further comprises:
removing a specified suffix from the first asset path, wherein the specified suffix does not correspond to the asset path format of the first asset type

15. The computing device of claim 12, wherein the first asset loading request indicates asset paths of a plurality of assets and wherein receiving the first asset loading request further comprises:
based on a number of assets in the plurality of assets being greater than a first threshold, dividing the plurality of assets into a plurality of asset path sets, wherein each asset path set has a number of asset paths not greater than the first threshold,
loading, as a batch, a first asset path set from the plurality of asset path sets; and
selecting, from the first asset path set, the first asset path of the first asset.

16. The computing device of claim 12, wherein receiving the first asset loading request further comprises:
based on a quantity of asynchronous asset loading requests being processed reaching a second threshold, adding the first asset loading request to a waiting queue; and
based on the quantity of asynchronous asset loading requests being processed being less than the second threshold and the first asset loading request being first in the waiting queue, removing the first asset loading request from the waiting queue.

17. One or more non-transitory computer readable media comprising computer readable instructions which, when executed, configure a data processing system to perform:
receiving a first asset loading request, the first asset loading request configured to asynchronously load a first asset, and the first asset loading request indicating a first asset path of the first asset;
obtaining a first asset type of the first asset;
determining whether the first asset path matches an asset path format of the first asset type;
based on determining that first asset path does not match an asset path format of the first asset type, correcting the first asset path; and
asynchronously loading the first asset based on the corrected first asset path.

18. The computer readable media of claim 17, wherein determining whether the first asset path matches an asset path format of the first asset type further comprises:
obtaining a suffix of the first asset path;
comparing the suffix of the first asset path to a suffix corresponding to the first asset type.

19. The computer readable media of claim 17, wherein receiving the first asset loading request further comprises:
based on a quantity of asynchronous asset loading requests being processed reaching a second threshold, adding the first asset loading request to a waiting queue; and
based on the quantity of asynchronous asset loading requests being processed being less than the second threshold and the first asset loading request being first in the waiting queue, removing the first asset loading request from the waiting queue.

20. The computer readable media of claim 19, wherein adding the first asset loading request to a waiting queue comprises:
inserting the first asset loading request into the waiting queue based on a priority of the first asset loading request and a priority of one or more existing asynchronous asset loading requests in the waiting queue.
